(19) United States
(12) Patent Application Publication
(10) Pub. No.: US 2006/0112091 A1
(43) Pub. Date: May 25, 2006

(54) Method and system for obtaining collection of variants of search query subjects

(75) Inventors: Jeffrey C. Chapman, Arlington, VA (US); Ahmed Qureshi, Cedar Hills, UT (US); Brian A. Kolo, Centreville, VA (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Harbinger Associates, LLC, Washington, DC (US)

(21) Appl. No.: 11/286,025

(22) Filed: Nov. 23, 2005

Related U.S. Application Data
(60) Provisional application No. 60/630,674, filed on Nov. 24, 2004.
(60) Provisional application No. 60/669,476, filed on Apr. 8, 2005.

(51) Int. Cl. G06F 17/30

(52) U.S. Cl. 707/4

(57) ABSTRACT

A method and system for identifying variants of one or more terms to be searched in a data collection, and searching such data collection to retrieve the terms and their variants, to ensure that all variants of the search term existing in the data collection are identified. A term that has been transliterated from a foreign language is separated into one or more letter sequences, at least some of which have associated therewith one or more variant letter sequences. A family of variants for the original term is constructed, and the original search term is compared against the newly constructed variants to reveal the presence or absence of a transliteration variant of the original search term in a data set.

### CROSS REFERENCE TO RELATED APPLICATION

This application is based upon and claims benefit of copending and co-owned U.S. Provisional Patent Application Ser. No. 60/630,674 entitled “Method and System for Transliteration of Search Terms”, filed with the U.S. Patent and Trademark Office on Nov. 24, 2004 by the inventors herein, and of copending and co-owned U.S. Provisional Patent Application Ser. No. 60/669,476 entitled “Method and System for Obtaining Collection of Variants of Search Query Subjects”, filed with the U.S. Patent and Trademark Office on Apr. 8, 2005 by the inventors herein, the specifications of which are incorporated herein by reference.

### BACKGROUND OF THE INVENTION

1. Field of the Invention

This invention relates to methods and systems for searching data collections, and more particularly to a method and system for identifying the presence of search terms and variants of such search terms in a data collection.

2. Background

There exist many commercial applications that require tools for enabling the search of a data collection to yield and display to a user a specifically desired subset of data from such collection. The World Wide Web is often used as a vast data source by users spanning the globe. Such users typically employ a search engine to construct queries which in turn are used to search various data repositories and return a subset of data relevant to their particularly query. Of course, such data search needs extend beyond the daily user of the World Wide Web, and are likewise used by users to search more narrow collections of data. By way of example, in the banking industry, a bank entity may wish to search bank customer names to whom new promotions are to be offered. In manufacturing industries, research and development personnel may wish to search patent data to determine relevant technological developments in their areas of research. In the airline industry, a passenger airline carrier may wish to search names of persons who have flown on their airline to offer future promotions, to follow up on lost luggage, or to identify specific persons that have previously flown on their airline whom third parties may wish to identify, such as law enforcement personnel. Of course, the applications for such search needs are so numerous that they cannot practically be catalogued.

Through the emergence of a global marketplace, such search needs have become more complex. For example, needs sometimes arise for persons to search terms from a foreign language that have no clear translation to their own language, such as names of foreign individuals or places. In this event, the person performing the search must first form their search query using a term in their own language that they believe most appropriately represents the phonetic representation of the foreign language term that is to be searched, i.e., by “transliterating” the foreign name to the user's own language.

This issue is made more complex by the fact that the first person's own language may have multiple ways of spelling the same sound. For instance, in English, the words “time” and “thyme” may be pronounced the same way, but are spelled differently. Thus, when an English speaker attempts to spell a name or other term from a foreign language that does not have a clearly established translation, the precise spelling produced will depend on what the English speaker hears and how he or she attempts to spell it phonetically. Thus, two different people may hear the same name and produce two different spellings. The various spellings commonly produced are referred to herein as transliteration variants.

Further compounding this issue is the fact that two transliteration variants may actually sound different when spoken in the target language. This is often the case when a transliteration of a word is done by individuals from different parts of the same country. For instance, in the United States, although English is the commonly spoken language, the way in which words are pronounced varies across the country. A single word, spelled the same everywhere, can sound different if it is spoken by a Northerner, a Southerner, or a Mid-Westerner. Thus, when people from these various regions transliterate the same spoken word, they will invariably arrive at different spellings.

Such issues may arise, for example, where an international banking employee in the United States is seeking to perform a credit check on an individual from a foreign country. In so doing, the employee in the United States will enter the customer's name into a database to locate any credit history attributable to that person. Of course, in order to enter the individual's name into such database, the employee in the United States must first formulate a word using the English alphabet that, in the employee's mind, most accurately reflects the phonetic sound of the customer's name as the employee heard and interpreted such customer's name. For example, one such employee having heard a new customer's name might enter such name as “Mohammed,” while another employee having heard that same customer's name might enter such name as “Muhamed,” and still another might enter “Muhammad,” despite the fact that all such entries in fact refer to the same individual. Likewise, if such new customer does have a credit history, that individual's credit records would likely be stored in some form associated with the customer's name as input by yet another person who had to craft an English term for the customer's name from their understanding of the phonetic sound of the foreign name. Thus, not only is there variability in the name that the original user might enter in a search query to find relevant data about the individual, but the available data sources themselves may have multiple representations of the individual's name in the user's language. Thus, in attempting to locate the particular person of interest (or any other term transliterated from a foreign language), the uncertainty inherent in formulating such query and in the existing data sets themselves creates significant risk that the records actually of interest will not be revealed from the search.

As a solution to this problem, attempts have been made to catalog over one billion personal names from around the world; however, even with more than one billion names catalogued, the search is still limited to that data set which contains an incomplete listing of all possible personal names. Computer programs have also been provided that attempt to parse names based upon the transliterated English spelling of a name in a foreign language, but is unfortunately based upon a limited, and thus flawed, set of English variants for each foreign name. It would therefore be desirable to provide a method and system capable of receiving as input a term transliterated to English from a foreign language, and search a data set to find occurrences of such term and transliteration variants of that term to ensure that the specific records of interest in the data set are revealed.

### SUMMARY OF THE INVENTION

Disclosed herein are systems and methods relating to the identification and collection of variants, and particularly of transliteration variants, of a search term in a given data collection. According to a first aspect of a particularly preferred embodiment, a transliterated term is analyzed and used as a basis to identify a family of transliteration variants for such term. For example, a listing of transliteration variants may be created by first separating the initial transliterated term into one or more letter sequences, each of which matches a pre-defined letter sequence in a library phonetically associating such pre-defined letter sequences in a first language with variant letter sequences in the first language and with variant letter sequences in a second language. A list is maintained of all variant letter sequences that correspond with such letter sequences that are identified in the initial transliterated term. After the initial transliterated term is separated into one or more letter sequences based upon their correlation with letter sequences in the library, the listing of transliteration variants is compiled by combining each variant of each letter sequence with each variant of each of the other letter sequences.

Each of the entries in the library may have a logical code associated therewith. Thus, instead of compiling a list of all transliteration variants associated with the initial transliterated term, one or more logical codes may be generated identifying a family or families of transliteration variants to which the initial transliterated term belongs.

With regard to another aspect of a particularly preferred embodiment, a user's search term, such as the name of an individual to be located in a data set, is processed as above to establish a family of transliteration variants for such search term, and the data set is searched to identify all members of such family of transliteration variants that are present in the data set. With regard to still another aspect of an alternate embodiment, a data set is first processed to create a family of transliteration variants for each item in the data set, and the user's query is searched against the expanded data set to identify any instances of the search term in the modified data set.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a flowchart depicting a method for searching a data collection for the presence of transliteration variants of a search term.

FIG. 2 is a flowchart depicting an automated method for searching a data collection for the presence of transliteration variants of a search term.

FIG. 3 is a flowchart depicting a method for preprocessing a data set into a collection of transliteration variants of such data set.

FIG. 4 is a flowchart depicting a method for mapping transliteration variants to logical codes.

FIG. 5 is a schematic view of a system for implementing the methods of FIGS. 1-4.

### DETAILED DESCRIPTION

The invention summarized above may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

It is noted that the method and system described herein are, for simplicity of explanation, set forth with reference to a particularly exemplary embodiment of searching for the name of a foreign individual, for example, an individual of Arabic origin, in a data set comprised of the names of multiple individuals in a language other than Arabic, such as English. However, the method and system set forth herein are not limited to such application, and can be used in any instance in which a term from a foreign language is to be searched in a data set comprised of data in another language.

A user desiring to search a data set, such as a passenger list, for the name of an individual of foreign origin is first faced with the challenge of determining how best to formulate their search query for that person's name. For instance, in the case of searching for the name of a person of Arabic origin, in which case there is no clearly defined English equivalent for the person's name, the user performing the search must first enter their interpretation of the phonetic sound of the Arabic name using the English alphabet, i.e., must transliterate the name from Arabic to English. As explained above, however, searching for that one user's interpretation of the correct transliteration will likely reveal incomplete and/or erroneous results. Thus, it is necessary from a conceptual standpoint to analyze the English transliterated term, determine the original Arabic term that the transliterated term refers to, and from the original Arabic term, determine all possible transliteration variants in English to compile the search query. To do so, it is noted that letters of the English alphabet may be mapped to letters of the Arabic alphabet, and that as a result, letter sequences in the English language may likewise be mapped to letter sequences in the Arabic language, and vice versa. However, it is also of note that there is not a one-to-one correlation of English letters to Arabic letters, such that an Arabic word might have multiple transliterations in the English language. For example, the Arabic letter [symbol] may be mapped to the English letters “a,” “i,” “u,” and “e”; the Arabic letter [symbol] may be mapped to the English letters “b” and “p”; and so on. Further, a single English letter may have multiple Arabic transliterations. For example, the English letter “t” may be mapped to the Arabic letters [symbol] and [symbol] .

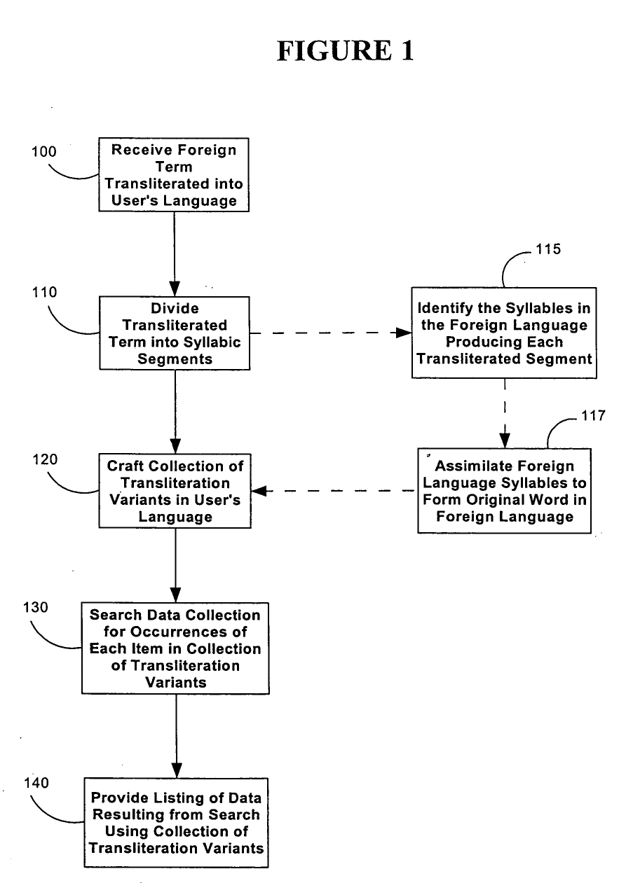

Thus, to provide a complete search for a transliterated term in a data set, it is preferable to process the original transliterated term (i.e., the term input in the English language by the user based upon their comprehension of the phonetic sound of the original foreign term) in accordance with the method depicted in FIG. 1. At step 100, a foreign term, such as an Arabic name, is transliterated into the user's own language. For example, the user, upon hearing the Arabic name, may craft a word using the English language that phonetically mirrors (in accordance with the user's comprehension of the Arabic term) the sound of the original Arabic term. Once that transliteration of the original Arabic term has been received, the transliterated English term is divided into syllabic segments at step 110. As used herein, “syllabic segments” or “syllables” is intended to encompass not only complete phonetic syllables, but also to encompass any sequence of one or more letters in a word.

At step 115, a corresponding syllabic segment in the original foreign language is identified which phonetically equates to each such segment of the original transliterated English term, and at step 117, those separate foreign language syllabic segments are assimilated to form the original foreign term. Once the original foreign term in the foreign language is identified, at step 120 the original foreign word is transliterated into a collection of transliteration variants in the user's language. That collection of transliteration variants (including the original transliterated term received at step 100) are then compared against the collection of data to be searched at step 130, and at step 140, a listing is produced of the occurrences in the data set of any of the transliteration variants produced in step 130.

Notably, the steps of identifying foreign syllabic segments and foreign words (steps 115 and 117) equating to the syllabic segments produced from the user's original transliterated term require consultation of a knowledge base, and more particularly a mapping of syllabic segments in the user's language to syllabic segments in the foreign language. However, as the end result of this sub-process is to craft a collection of transliteration variants in the user's language from the transliterated syllabic segments of the originally transliterated term, a direct mapping of syllabic segments in the user's language to transliteration variants of those syllabic segments in the user's language can likewise be developed. Thus, as shown in FIG. 1, the process may likewise be carried out by omitting steps 115 and 117, and instead after creating the separate syllabic segments of the originally transliterated term at step 110, consulting a knowledge base that maps those segments in the user's language to transliteration variants of those segments in the user's language, and thereafter compiling the collection of transliteration variants in the user's language from those segments at step 120.

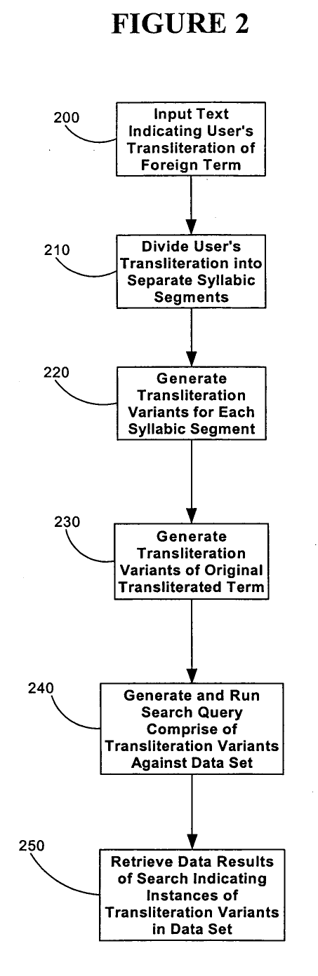

An automated method and system are provided to implement the general transliteration search method described above. More particularly, as shown in FIG. 2, in a computer implemented system, input is received from a user at step 200 in the form of text indicating the user's transliteration of a foreign term that is to be searched in an electronic data set, such as the occurrence of a particular foreign name in a listing of multiple names, such as a bank customer list, an airline passenger list, etc. At step 210, the user's transliteration is divided into separate segments evidencing the separate letter sequences in the user's language that comprise the user's transliterated term. To accomplish such separation and generation of separate syllabic segments, and as explained in greater detail below, starting from the beginning of the term, each adjacent series of letters in the transliterated term are compared against a predefined list of syllabic segments in a transliteration library (discussed in detail below) until a predetermined syllabic segment is recognized. When recognized (or if a syllabic segment in the original transliterated term has no matching entry in the transliteration library), such segment is extracted from the remainder of the term, and the process at step 210 continues until all characters in the original transliterated term have been extracted, thus resulting in the creation of a plurality of syllabic segments (at least for those transliterated terms that are comprised of multiple syllabic segments). After the syllabic segment or segments have been generated, at step 220, the transliteration library is again consulted to identify transliteration variants for each of the syllabic segments, and a list of potential alternative spellings for each such segment is generated. From the list of potential alternative spellings, at step 230, transliteration variants of the original transliterated term are generated by combining the alternative spellings for each segment produced from step 220, and more particularly by combining each variant of each syllabic segment with each variant of each of the other syllabic segments, resulting in the production of multiple, and potentially a large number (possibly even thousands) of transliteration variants corresponding to possible spellings of the original Arabic term in English.

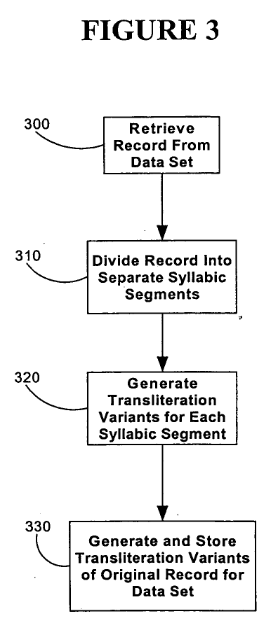

After the list of transliteration variants is generated, a query is generated at step 240 comprised of the set of transliteration variants from step 230 and is run against the data set of interest to, at step 250, retrieve records from the data set that include any of the transliteration variants. Alternately, and as discussed in greater detail below with regard to FIG. 3, the above method may be employed to process each entry in the data set at step 200, thus generating a list of transliteration variants for each entry in the data set, and run the user's original search term against the modified and expanded data set. These processes thus allow the searcher to find entries in the data set that relate to their original transliterated term, despite the fact that the entries in the original data set do not match the original transliterated term.

Optionally, after the records have been retrieved at step 250, a rating algorithm may be applied to the results set to calculate a confidence number evidencing a measure of correlation between the original search term and each record retrieved at step 250. The algorithm computes such confidence number by examining how closely the match results correspond to the original search term. For instance, a user may search on a first, middle, and last name of an individual, and a match may be found to the first and last names. The confidence number for such match would be less than the rating for a match that found the first, middle, and last names. Notably, the precise number assigned to each record is not critical, such that the rating algorithm may be adapted to provide any range of numerical scores, it simply being important to ensure that an objective quantification be provided that is capable of demonstrating the comparative degree of correlation between any two search results and the original search term.

The above-described method for generating the collection of variants for the user's query will now be discussed with greater particularity. First, the sounds of the target language are broken down into base written elements. These may be as simple as individual letters or may be more complicated sequences of letters. All letter sequences that can produce the same sound should be grouped. A complete group of letter sequences that all can produce the same sound is referred to herein as a “sound family.” If a complete set of sound families is found, a map can be constructed mapping one transliteration variant to all other transliteration variants corresponding to the same spoken word.

First we will detail some of the properties of a sound family. It is not necessary for the letter sequences in a sound family to always produce the same sound, only that they can produce the same sound. For instance, since “thyme” and “time” sound the same, we may group “i” and “hy” into the same sound family even though “i” and “hy” do not always indicate the same sound.

Additionally, two different sound families may both contain the same letter sequence. Continuing with the example, we may also have a sound family containing “hi” and “hy” (since these can produce the same sound). In this case, “hy” appears in two separate sound families. This can happen since “hy” may produce a different sound in different words. Thus, “hy” appears once in the first family (since it can take on an “i” sound) and once in the second family (since it can also have a “hi” sound).

The sound families give rise to the transliteration variants. Since the letter sequences in a sound family can have the same sound in a word, they can produce different spellings. For instance, a name like Himmler may be transliterated either as Himmler or Hymmler since the “hi” and “hy” sounds are both in the same sound family. In fact, if we knew all of the sound families, we could arrive at every possible spelling of Himmler. This would produce every possible transliteration variant.

Since it is the sound families that produce the transliteration variants, we should look to construct a set of sound families which is as complete as possible. In order to construct the sound families, we begin by distinguishing between the sources of the letter sequences we put into the sound families. There are two main sources: sources arising within the target language (intralingua sources) and sources arising between the original and target languages (interlingua sources). Each of these sources should be analyzed to discover the potential set of sound families.

The intralingua sources can be found from an examination of the target language. English examples such as i, y, hy or hi and hy show an intralingua source of sound families. A complete set of intralingua sound families may be discovered by comparing the spellings of words within the language that have similar sounds.

The interlingua sources arise from a sound in the original language that does not have a direct representation in the target language. For instance, there is a sound in Arabic that may be spelled using the English alphabet as ah, ak, or ack. From this we might create a sound family containing h, k and ck. This grouping does not exist in English, but arises from the way English speakers hear this Arabic sound.

Since the sound families arise from both intralingua and interlingua sources, finding a complete set of sound families will necessitate the examination of both the target and original languages. This examination will produce a complete set of sound families incorporating the nuances of both the target and original languages.

Once the complete set of sound families has been produced, the map correlating all transliteration variants for a single spoken word can be constructed. This is accomplished by first identifying the set of unique letter sequence across all sound families. Starting with a transliterated word, first identify all of the letter sequences in that word that are present in the sound families. Next, for each letter sequence matched to a sound family, lookup the alternative letter sequences in that sound family. Create a list of words by replacing the matched sequence with every letter sequence in the sound family. This process is then repeated for each letter sequence found and will produce the transliteration family for the transliterated word.

This map will solve the transliteration problem if the original language is separable with respect to the target language. Given two transliteration variants, pick one and use the map to produce the transliteration family. If two words belong to the same transliteration family, and if the original language is separable with respect to the target language, the transliterated words must correspond to the same original word.

Although formally solved, the method above does not produce a tractable solution to the transliteration problem. Because of the degree of complexity of most languages, the list of all unique letter sequences across the sound families is usually large. Thus, the number of variants in a transliteration family is large, often numbering in the trillions or more. Further, the cardinality of the transliteration family increases exponentially with the length of the transliterated word since with each letter added we will have all the old exchanges plus anything new the additional letter adds. The total number of variants produced is found by multiplying together the exchanges. Thus, as the length of the variant is increased, the number of variants present in the transliteration family grows exponentially.

In a practical problem, there is typically a preexisting set of transliteration variants present. A test variant is provided and the transliteration problem amounts to checking whether the test variant is present on the preexisting list. In this case, the processing time may be increased by preprocessing the variants in the preexisting set. With this composite list present, a new variant may be simply checked against the composite list and there is no need to compute a large transliteration family for the test variant. Using this preprocessing concept, the lookup time is significantly reduced in exchange for storage of a large list of transliteration families for the preexisting set. As shown particularly in FIG. 3, in an alternate embodiment a record is first retrieved from the data set to be searched at step 300, and is thereafter divided into syllabic segments at step 310 (in accordance with the method described above with regard to the analysis of a user's search term) evidencing the separate letter sequences in the intended user's language that comprise the original record. To accomplish such separation and generation of separate syllabic segments, starting from the beginning of the record, each adjacent series of letters in the record are compared against a predefined list of segments in the transliteration library until a predetermined syllabic segment is recognized. When recognized, such segment is extracted from the remainder of the term, and the process at step 310 continues until all characters in the original record are extracted, thus resulting in the creation of a plurality of syllabic segments (at least for those records that are comprised of multiple syllabic segments). After the syllabic segment or segments have been generated, at step 320, the transliteration library is consulted to identify transliteration variants for each of the syllabic segments, and a list of potential alternative spellings for each such segment is generated. From the list of potential alternative spellings, at step 330, transliteration variants of the original record are generated by combining the alternative spellings for each segment produced from step 320, and more particularly by combining each variant of each syllabic segment with each variant of each of the other syllabic segments, resulting in the production of multiple transliteration variants corresponding to possible spellings of the original record. Such transliteration variants are then stored, along with the original record, in a modified data set to observe as the data set against which the intended user's search will run.

In this alternate embodiment, after such pre-processing is completed and the modified data set is generated, a user may enter a term which will be searched against the transliteration variants already compiled and stored in the modified data set. This process reduces searching time because it is unnecessary to search the dataset for each transliterated variant of the search term, as every possible variant in the dataset has already been discovered and stored in the modified data set.

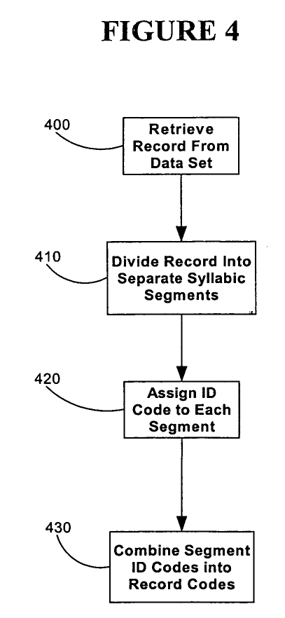

In yet another embodiment, an additional map may be created that maps all members of a transliteration family to a unique logical element. As shown in FIG. 4, at step 400, a data record is retrieved from the data set, and at step 410, that data record is divided into separate syllabic segments as described above with reference to step 310 of FIG. 3. After the separate syllabic segments are generated for such record, another lookup table is consulted which links each transliteration variant of each syllabic segment to a unique logical element, such as a numeric code, and such logical element is thus assigned to each syllabic segment at step 420. After a logical element has been assigned to each syllabic segment, at step 430 those codes are compiled to form an identification key for the particular record. By using a knowledge base that links transliteration variants of syllabic segments to numeric keys, all transliteration variants of a single word will map to the same identification key. Thus, when performing a search, the user enters a search word, and that search word is processed as set forth above with reference to FIG. 4 to generate an identification key for that search term. The data set is then searched for that identification key, and all matches (i.e., all stored transliteration variants associated with the identification key determined for the search term) are returned to the user. Optionally, filters may be provided to remove results that are not proper matches (i.e., for those instances in which different words map to the same key).

More particularly, any sound families that have a common element are combined. This should be repeated until the remaining sound families have no members in common. At this point, a unique value may be assigned to each sound family. A logical value may be formed by replacing each letter segment in the variant by the assigned logical value.

We call the logical value created through this process the “fine structure” of the variant. This process guarantees that two members of a transliteration family will map to the same logical value. This logical value is a topological invariant of the transliteration family. Thus, two variants may be quickly checked. If they produce different logical values, they must belong to different transliteration families. However, because of the unioning process used to create the non-intersection sound families, two different variants may produce the same fine structure. Thus, for two variants to belong to the same transliteration family, it is necessary that their fine structures have the same value. However, this condition is not sufficient to prove they do belong to the same transliteration family since this topological invariant is not necessarily classifying.

There is another mapping that may be employed to further distinguish transliteration variants. First, assign each sound family a unique identifier. Next, create a list of all possible letter sequences and to each sequence, track a list of all of the sound families that the letter sequence appears. When given a transliteration variant, create a logical value by replacing the letters sequences identified in the variant by all possible logical values assigned to the sequence.

We call the logical value created through this process the “hyperfine structure” of the variant. Although this has the potential to create exponentially many hyperfme structures, in practice it does not since most letter sequences appear in only one sound family. This process creates a small set of hyperfine values. When comparing two variants, if any of the hyperfine structures of one variant appear on the second variant, the two variants must belong to the same transliteration family. Thus, this condition is both necessary and sufficient to prove two variants belong to the same transliteration family.

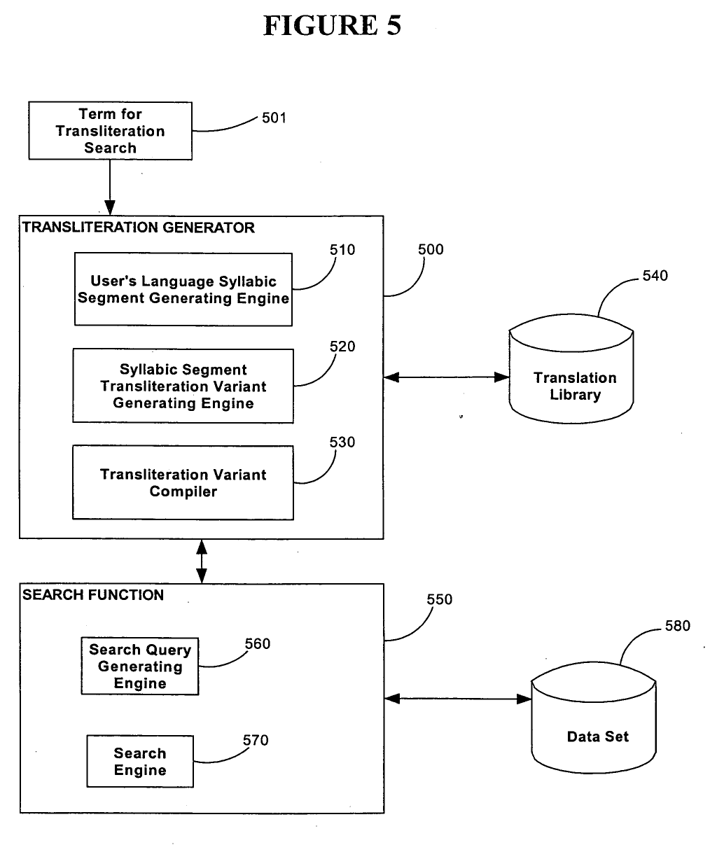

FIG. 5 is a schematic view of a system for implementing the methods of the instant invention. As shown, a term intended for a transliteration search of a data set 580 is input to a transliteration generator 500. Transliteration generator 500 in turn comprises a user's language syllabic segment generating engine 510 capable of analyzing term 501 and, in consultation with a transliteration library 540, separating term 501 into separate syllabic segments, a syllabic segment transliteration variant generating engine 520 capable of determining (again in consultation with transliteration library 540) the transliteration variants of each such syllable, and a transliteration compiler 530 capable of compiling the transliteration variants of such syllabic segments into transliterations of the original term 501. With reference to the methods described in detail above, transliteration generator 500 may be used to transliterate the search term itself or records in the data set intended to be searched (shown at 580 in FIG. 5). Transliteration generator 500 is preferably in communication with a search function 550 which in turn houses a search query generating engine 560 and a search engine 570. Search query generating engine 560 receives either term 501 or the transliterations for such term produced by transliteration generator 500 (depending upon the particular embodiment utilized) and generates a query which in turn is used by search engine 570 to query data set 580. Records identified by such query are returned to search engine 570 and preferably presented to the user.

Transliteration library 540 preferably includes a listing of letter sequences in a first language (e.g., English) having intralingua variants, and more particularly letter sequences that map to one or more variant letter sequences having a generally equivalent phonetic pronunciation in the first language to the particular letter sequence. Transliteration library 540 also preferably includes a listing of letter sequences in a first language having interlingua variants, and more particularly letter sequences that map to one or more variant letter sequences having a similar phonetic pronunciation in a second language to the particular letter sequence. Transliteration library 540 may further include a listing of combined intralingua and interlingua variants, in which those entries in each that have any variant letter sequences in common are combined into a single entry. As discussed above and in the example that follows, such combined intralingua and interlingua variant tables may further include hyperfine structures, in which a unique code is assigned to each entry in a hyperfine structure table having combined hyperfine structures for each entry in the intralingua and interlingua variant tables, and fine structures, in which a unique code is assigned to each entry in a fine structure table having combined fine structures for each entry in the intralingua and interlingua variant tables.

### EXAMPLES

This section provides a simple example of the tools and techniques described in the previous sections. This example will not focus on a complete example as the complexity of languages produces many sound families and many transliteration variants. Instead, a smaller example will be engaged.

The example will use Arabic as the original language and English as the target language. First, the intralingua sound families should be identified. As an example, note that i, y, and hy can have the same sound as well as hi and hy. Also, the sequences 11, 1, and 1e have the same sound (compare control, roll, role). This produces the three sound families shown in table 1. When creating the fine structure table, we combine any sound families that have a common letter sequence. Doing so produces the fine structure shown in table 2.

TABLE 1
An example of three sound families from English with
their letter sequences and sample hyperfine values.

| Sound | Letter Sequences |
|---|---|
| i | i, y, hy |
| hi | hi, hy |
| l | l, ll, le |

TABLE 2
An example of sound families for the fine structure from Table 1.

| Sound | Letter Sequences |
|---|---|
| i, hi | i, y, hy, hi |
| l | l, ll, le |

Next, the interlingua sound families must be determined. As an example, the Arabic transliteration of h, k, and ck are the same. Likewise, the Arabic transliterations for a, e, i, and u are also the same. Tables 3 and 4 provide the hyperfine and fine structures for these sounds.

TABLE 3
An example of three sound families from Arabic with
their letter sequences and sample hyperfine values.

| Sound | Letter Sequences |
|---|---|
| h | h, k, ck |
| a | a, e, i, u |

TABLE 4
An example of sound families for the fine structure from Table 3.

| Sound | Letter Sequences |
|---|---|
| h | h, k, ck |
| a | a, e, i, u |

With the intralingua and interlingua sound families identified, we proceed by combining the two tables to produce a single fine and hyperfine structure table. This is done by combining any letter sequence found commonly between them. The result is shown in tables 5 ad 6.

TABLE 5
The combined hyperfine structure from tables 1 and 3.

| Sound | Letter Sequences | Hyperfine Structure |
|---|---|---|
| i, a | i, y, hy, a, e, u | 1 |
| hi | hi, hy | 2 |
| l | l, ll, le | 3 |
| h | h, k, ck | 4 |

TABLE 6
The combined fine structure from tables 2 and 4.

| Sound | Letter Sequences | Fine Structure |
|---|---|---|
| i, hi, a | i, y, hy, hi, a, e, i, u | 5 |
| l | l, ll, le | 6 |
| h | h, k, ck | 7 |

Using these tables, we can construct all of the transliteration family, the fine structure and hyperfine structure for any transliteration variant. We will assume that any letter not present as a sequence in the above tables will have the value 0. As an example, examine the transliteration family for the word hyphen.

hy p h e n
Fine Structure - 50750
Hyperfine Structure - 20410, 10410

Now examine the word hiphun:

hi p h u n
Fine Structure - 50750
Hyperfine Structure - 20410

We see that these variants belong to the same transliteration family. First, the fine structures are identical indicating they may belong to the same transliteration family. Second, examining the hyperfine structure, we see they have a common hyperfine structure value, namely 20410. Since they have a hyperfine element in common, they must belong to the same transliteration family.

This process is a great improvement over the direct calculation of every transliteration variant. We see this by counting the number of transliteration variants of the word hyphen:
hy—8 variants (8 variants related to hy in table 5)
p—1 variant
h—3 variants (3 variants related to h in table 5)
e—6 variants (6 variants related to e in table 5)
n—1 variant
Total variants: 8×1×3×6×1=144

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A method for identifying variants of a search term in a data set, comprising the steps of:
(a) providing a library having a plurality of library letter sequences comprising one or more letters, wherein each library letter sequence is associated with a family of one or more variant letter sequences, and wherein said variant letter sequences include both intralingua variants and interlingua variants;
(b) receiving an initial term;
(c) separating said initial term into initial term letter sequences at least some of which match one or more library letter sequences in said library;
(d) identifying each family of variant letter sequences in said library to which each of said initial term letter sequences belong; and
(e) compiling one or more alternate terms to said initial term by combining at least a code associated with each family of variant letter sequences to which each initial term letter sequence belongs, with each code associated with each family of variant letter sequences to which each other initial term letter sequence belongs.

2. The method of claim 1, wherein at least one of said families of one or more variant letter sequences in said library include variant letter sequences from both intralingua variants and interlingua variants.

3. The method of claim 1, wherein said initial term further comprises a term that has been transliterated from a foreign language into a native language.

4. The method of claim 1, wherein said code associated with each family of variant letter sequences further comprises a single variant letter sequence selected from a family of variant letter sequences to which a respective initial term letter sequence belongs.

5. The method of claim 4, said compiling step further comprising combining each single variant letter sequence in each family of variant letter sequences to which a respective initial term letter sequence belongs, with each single variant letter sequence in each family of variant letter sequences to which each of the other initial term letter sequences belong, to generate one or more transliteration variants of said initial term.

6. The method of claim 1, wherein said code associated with each family of variant letter sequences further comprises a numeric value.

7. The method of claim 6, said compiling step further comprising combining each numeric value for each family of variant letter sequences to which a respective initial term letter sequence belongs, with each numeric value for each family of variant letter sequences to which each of the other initial term letter sequences belong, to generate one or more numeric transliteration codes of said initial term.

8. The method of claim 1, wherein said initial term further comprises a search term received from a user.

9. The method of claim 8, further comprising the steps of:
(f) searching a data set to identify the presence of any of said alternate terms in said data set; and
(g) presenting any matching terms to said user.

10. The method of claim 1, wherein said initial term further comprises an entry in a data set that is to be searched to identify the presence of variants of a user's search term.

11. The method of claim 10, further comprising the steps of:
(f) repeating steps (b) through (e) for each entry in said data set to create a transliterated data set;
(g) receiving a search term from a user;
(h) searching said transliterated data set to identify the presence of said search term in said transliterated data set; and
(i) presenting any matching terms in said transliterated data set to said user.

12. A system for identifying variants of a search term in a data set, comprising:
a server computer in communication with a plurality of remote user computers configured for the exchange of data there between, said server computer having access to an electronic library having a plurality of library letter sequences comprising one or more letters, wherein each library letter sequence is associated with a family of one or more variant letter sequences, and wherein said variant letter sequences include both intralingua variants and interlingua variants, and said server computer having executable computer code stored thereon adapted to:
(a) receive an initial term;
(b) separate said initial term into initial term letter sequences at least some of which match one or more library letter sequences in said library;
(c) identify each family of variant letter sequences in said library to which each of said initial term letter sequences belong; and
(d) compile one or more alternate terms to said initial term by combining at least a code associated with each family of variant letter sequences to which each initial term letter sequence belongs, with each code associated with each family of variant letter sequences to which each other initial term letter sequence belongs.

13. The system of claim 12, wherein at least one of said families of one or more variant letter sequences in said library include variant letter sequences from both intralingua variants and interlingua variants.

14. The system of claim 12, wherein said initial term further comprises a term that has been transliterated from a foreign language into a native language.

15. The system of claim 12, wherein said code associated with each family of variant letter sequences further comprises a single variant letter sequence selected from a family of variant letter sequences to which a respective initial term letter sequence belongs.

16. The system of claim 15, said executable code adapted to compile alternate terms being further adapted to combine each single variant letter sequence in each family of variant letter sequences to which a respective initial term letter sequence belongs, with each single variant letter sequence in each family of variant letter sequences to which each of the other initial term letter sequences belong, to generate one or more transliteration variants of said initial term.

17. The system of claim 12, wherein said code associated with each family of variant letter sequences further comprises a numeric value.

18. The system of claim 17, said executable code adapted to compile alternate terms being further adapted to combine each numeric value for each family of variant letter sequences to which a respective initial term letter sequence belongs, with each numeric value for each family of variant letter sequences to which each of the other initial term letter sequences belong, to generate one or more numeric transliteration codes of said initial term.

19. The system of claim 12, wherein said initial term further comprises a search term received from a user.

20. The system of claim 19, said executable code being further adapted to:
(f) search a data set to identify the presence of any of said alternate terms in said data set; and
(g) present any matching terms to said user.

21. The system of claim 12, wherein said initial term further comprises an entry in a data set that is to be searched to identify the presence of variants of a user's search term.

22. The system of claim 21, said executable code being further adapted to:
(f) conduct steps (b) through (e) for each entry in said data set to create a transliterated data set;
(g) receive a search term from a user;
(h) search said transliterated data set to identify the presence of said search term in said transliterated data set; and
(i) present any matching terms in said transliterated data set to said user.

23. A computer implemented method for searching a data set to identify transliteration variants of a search term, comprising the steps of:
(a) providing an electronic library comprising a plurality of library records, each of said library records further comprising one or more letter sequences defining a sound family, at least some of said sound families in said library including both intralingua variants and interlingua variants;
(b) receiving a search query from a user comprising a search term in a native language that has been transliterated from a foreign language;
(c) separating said search term into search term letter sequences; and
(d) identifying all sound families in said electronic library having a letter sequence matching the search term letter sequences of step (c).

24. The method of claim 23, further comprising the step of:
(e) compiling one or more transliteration variants of said search term by combining each letter sequence of each sound family identified in step (d) with each letter sequence of each of the other sound families identified in step (d).

25. The method of claim 24, further comprising the steps of:
(f) searching a data set to identify the presence of any of said search term and said transliteration variants in said data set; and
(g) presenting any matching terms in said data set to a user.

26. The method of claim 23, each of said library records further comprising a logical code associated with each sound family, the method further comprising the step of:
(e) compiling one or more search term transliteration codes identifying transliteration variants of said search term by combining a logical code for each sound family identified in step (d) with each logical code of each of the other sound families identified in step (d).

27. The method of claim 26, further comprising the steps of:
(f) repeating steps (c) through (e) for each term in a data set to generate one or more transliteration codes for each entry in said data set;
(g) searching said data set to identify the presence of any of said search term transliteration codes in said data set; and
(h) presenting any data elements having matching transliteration codes in said data set to a user.
